(19) United States
(12) Patent Application Publication
(10) Pub. No.: US 2022/0013808 A1
(43) Pub. Date: Jan. 13, 2022

(54) BATTERY COMPOSITION

(71) Applicant: Global Nano Network Limited, Surrey (GB)

(72) Inventors: Juan Scott CHAVES NOGUERA, Surrey (GB); María José MORERA GÓMEZ, Surrey (GB); Sindy Johanna CHAVES NOGUERA, Surrey (GB)

(73) Assignee: Global Nano Network Limited, Surrey (US)

(21) Appl. No.: 17/288,585

(22) PCT Filed: Oct. 25, 2019
(86) PCT No.: PCT/GB2019/053035

§ 371 Date: Apr. 26, 2021

(30) Foreign Application Priority Data
Oct. 26, 2018 (GB) 1817450.8

(51) Int. Cl. H01M 10/0565; H01G 9/028

(52) U.S. Cl. CPC H01M 10/0565; H01G 9/028; C08B 37/003; H01M 2300/0082; H01M 2220/20; H01M 2300/0085

(57) ABSTRACT

An electrolyte is disclosed, for example for use in a capacitor or in a battery. An electrolyte comprises a polysaccharide matrix; and carbon nanotubes embedded within the polysaccharide matrix. Further, apparatus comprising the electrolyte is disclosed. A method of manufacturing an electrolyte is disclosed. According to the method a polysaccharide solution is provided; carbon nanotubes are suspended within the polysaccharide solution; and the polysaccharide solution is dehydrated to obtain a gel.

### FIELD OF THE DISCLOSURE

The present disclosure relates to a battery composition. More particularly, it relates to an electrolyte comprising carbon nanotubes (CNTs) suspended in a natural polysaccharide.

### BACKGROUND

Electronic devices, electric vehicles, and renewable energy sources are all in widespread use. Within each of these technologies, batteries are often used to store and provide power. Problematically, present battery designs are often volatile, environmentally harmful, or have a low storage capacity.

According to an aspect of the present invention there is provided an electrolyte comprising: a polysaccharide matrix; and carbon nanotubes embedded within the polysaccharide matrix.

The polysaccharide matrix can provide a matrix that is biocompatible and gives good electrolytic properties. Carbon nanotubes can enable favourable charge mobility in the electrolyte and at an electrode.

The electrolyte may further comprise sulfur embedded within the polysaccharide matrix. Sulfur can enable favourable charge mobility in the electrolyte and at an electrode.

Preferably the sulfur is in the form of sulfur nanoparticles. This can enable particularly high effectivity.

The sulfur may be bound to the carbon nanotubes for effectivity.

The carbon nanotubes may be chiral carbon nanotubes.

The polysaccharide may be derived from a natural polysaccharide, preferably at least one of: chitin, agarose, starch, and/or glycogen. The polysaccharide may be agarose. The polysaccharide may have a melting temperature between 70 and 110° C.

Preferably the polysaccharide is agarose. Preferably the polysaccharide is chitosan. Chitosan can provide a particularly cost effective, biocompatible, biodegradable, and effective matrix for the electrolyte. The chitosan may be obtained from the shells of crustaceans. The chitosan may have a degree of deacetylation of 60-95%, preferably 70-90%, and more preferably approximately 80%. The chitosan may have an average molecular weight of 50 to 1500 kDa, preferably 50 to 900 kDa, preferably 50 to 300 kDa, and more preferably approximately 200 kDa. The chitosan may have a molecular weight such that a viscosity of a solution of the chitosan at 10 mg/mL in 1% acetic acid at 20° C. is 30 to 1000 cPs, preferably 50 to 800 cPs, more preferably 100 to 750 cPs, more preferably 100 to 300 cPs, more preferably 150 to 250 cPs, more preferably 10 to 200 cPs, more preferably approximately 200 cPs.

The electrolyte may further comprise a nonionic surfactant, for example to prevent clustering of the sulfur.

The electrolyte may further comprise one or more of: sodium cations; chloride; phosphate; and potassium cations. Inclusion of different ions can provide favourable charge mobility in the electrolyte and at an electrode.

The electrolyte may further comprise polyethylene glycol.

For effectiveness the carbon nanotubes may be functionalized with sulfur. The carbon nanotubes may be functionalized with sulfur by a torch of cold plasma.

For effectiveness the carbon nanotubes may be oriented within the matrix, preferably using an electrophoresis process.

The carbon nanotubes may be arranged at an interface of the polysaccharide matrix.

The carbon nanotubes may be dispersed throughout the polysaccharide matrix. The sulfur may be arranged at an interface of the polysaccharide matrix. The sulfur may be dispersed throughout the polysaccharide matrix. The sulfur and/or the carbon nanotubes may be dispersed throughout the polysaccharide matrix using an ultrasound treatment.

The electrolyte may be formed by exposure of the electrolyte to irradiation, preferably ultraviolet irradiation, more preferably irradiation at 200 nm to 300 nm.

According to another aspect there is provided apparatus comprising the electrolyte as aforementioned, further comprising: a first electrode; and optionally a second electrode; wherein the electrolyte is disposed adjacent the first electrode and optionally between the first electrode and the second electrode.

Preferably the first electrode comprises magnesium and/or the second electrode comprises copper. Magnesium can provide a particularly effective and non-hazardous and biocompatible electrode, and copper can provide a particularly effective and non-hazardous and environmentally friendly electrode. By virtue of the electrolyte these specific electrode materials can be particularly effective.

The first electrode and/or the second electrode may comprise sulfur, preferably sulfur nanoparticles, for effectivity.

According to another aspect there is provided a battery and/or capacitor comprising the electrolyte as aforementioned or the apparatus as aforementioned.

Preferably the battery and/or capacitor is at least one of: a solid-state battery and/or capacitor, a biodegradable battery and/or capacitor, and a flexible battery and/or capacitor.

According to another aspect there is provided a method of manufacturing an electrolyte, the method comprising: providing a polysaccharide solution; suspending carbon nanotubes within the polysaccharide solution; and dehydrating the polysaccharide solution to obtain a gel (preferably a xerogel).

The polysaccharide can provide a matrix that is biocompatible and gives good electrolytic properties. Carbon nanotubes can enable favourable charge mobility in the electrolyte and at an electrode.

The method may comprise suspending sulfur within the polysaccharide solution. Sulfur can enable favourable charge mobility in the electrolyte and at an electrode.

The polysaccharide solution is preferably a chitin or chitosan or agarose solution.

The polysaccharide solution preferably comprises at least: polysaccharide, water, and optionally one or more of: sodium cations; chloride; phosphate; potassium cations; and polyethylene glycol.

The method preferably further comprises arranging the carbon nanotubes at an interface of the polysaccharide matrix and/or dispersed throughout the polysaccharide matrix, optionally using an ultrasound treatment.

The method preferably further comprises orienting the carbon nanotubes, preferably within the polysaccharide solution, optionally within the dehydrated polysaccharide. Orienting the carbon nanotubes may comprise using an electrophoresis process.

Dehydrating the polysaccharide solution may comprise mechanically dehydrating the polysaccharide solution.

The sulfur may be sulfur nanoparticles. The method may further comprise binding the sulfur to the carbon nanotubes. The binding may comprise using a torch of cold plasma.

Providing a polysaccharide solution may comprise treating chitin to obtain chitosan, preferably wherein the chitin is obtained from the shells of crustaceans.

The carbon nanotubes may be chiral carbon nanotubes.

The method may further comprise exposure of the electrolyte to irradiation, preferably ultraviolet irradiation, more preferably irradiation at 200 nm to 300 nm.

According to another aspect there is provided a method of manufacturing an apparatus comprising manufacturing the electrolyte as aforementioned, further comprising: providing a first electrode; optionally providing a second electrode; and disposing the electrolyte adjacent the first electrode and optionally between the first electrode and the second electrode. Preferably the first electrode comprises magnesium and optionally the second electrode comprises copper.

According to another aspect there is provided a method of manufacturing a battery or capacitor comprising manufacturing the electrolyte as aforementioned or manufacturing apparatus as aforementioned. Preferably the battery or capacitor is at least one of: a solid-state battery or capacitor, a biodegradable battery or capacitor, and a flexible battery or capacitor.

Any feature in one aspect of the disclosure may be applied to other aspects of the invention, in any appropriate combination. In particular, method aspects may be applied to apparatus aspects, and vice versa.

Any apparatus feature as described herein may also be provided as a method feature, and vice versa.

It should also be appreciated that particular combinations of the various features described and defined in any aspects of the disclosure can be implemented and/or supplied and/or used independently.

The disclosure extends to methods and/or apparatus substantially as herein described with reference to the accompanying drawings.

As used herein, the term matrix may refer to a network, a polymer network, a gel, a xerogel, a hydrogel, or an aerogel.

The disclosure will now be described by way of example, with references to the accompanying drawings in which:

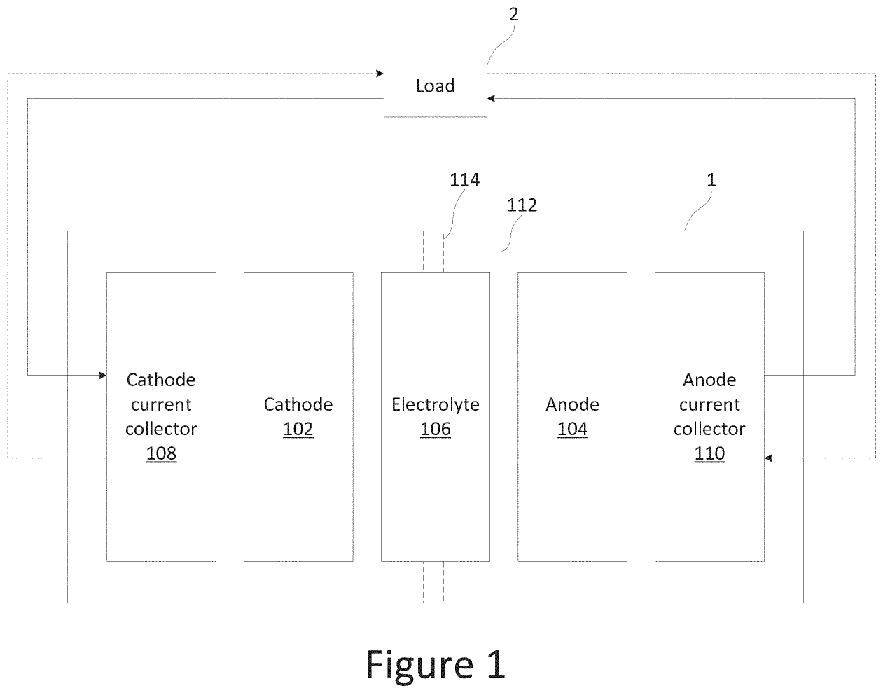

FIG. 1 shows a component view of a battery;

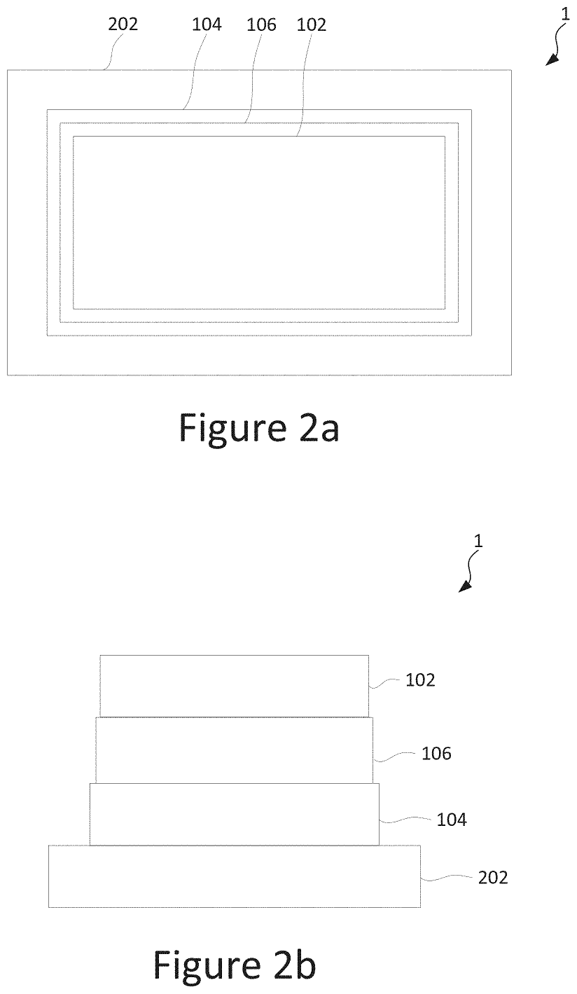

FIGS. 2a and 2b show plan and side views of an exemplary embodiment of the battery;

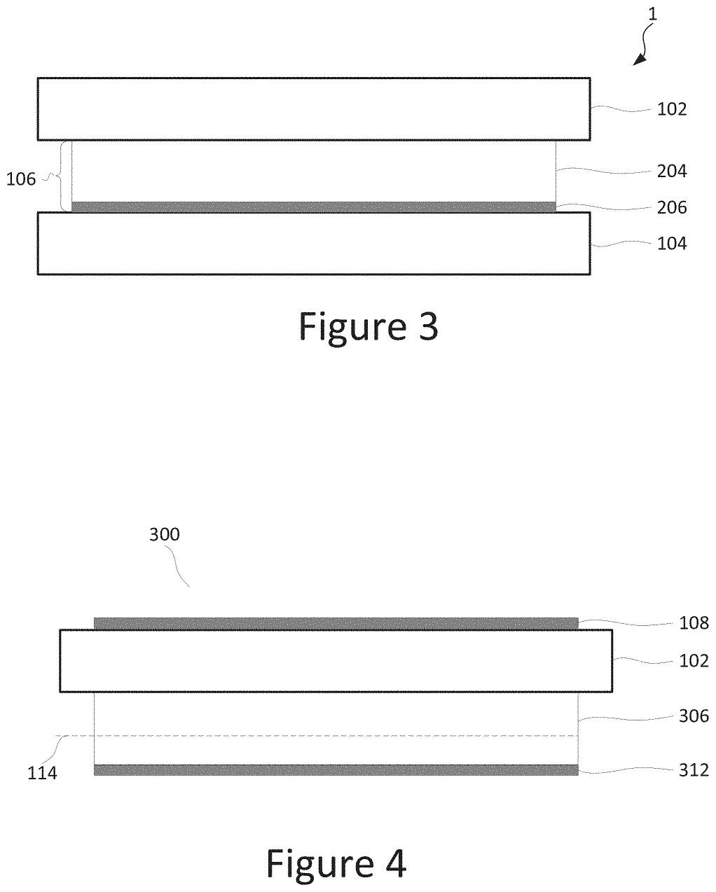

FIG. 3 shows a variant of the electrolyte with a base layer and a second layer; and

FIG. 4 shows a cross sectional view of a battery 300 where the electrolyte 306 performs as anode.

There is shown in FIG. 1 a component view of a battery 1.

The battery includes a cathode 102, an anode 104, an electrolyte 106 disposed between the cathode 102 and the anode 104, a cathode current collector 108, an anode current collector 112, and a separator 114. In typical embodiments, each component is arranged to be in contact with adjacent components, that is: the cathode 102 contacts the electrolyte 106 and cathode current collector 108; and the anode 104 contacts the electrolyte 106 and the anode current collector 110.

The battery is arranged to ‘discharge’ to, that is provide stored power to, an external load 2 and to ‘charge’ from, that is receive and store power from, the external load 2.

The cathode 102 is an electrode which is arranged to be reduced during the discharging of the battery 1; this comprises gathering electrons provided by the cathode current collector 108. The anode 104 is an electrode which is arranged to be oxidized during the discharging of the battery 1; this oxidization provides electrons that are collected by the anode current collector 110. The cathode 102 and anode 104 are each capable of being reduced and oxidized, so that during charging of the battery 1, the cathode 102 is oxidized and the anode 104 is reduced. More generally, the battery 1 may be considered to have two electrodes, each of which may act as a cathode or an anode.

One of the electrodes typically is formed of a metal oxide or a sulfide, such as a copper sulfide. The electrode may be copper covered by a thin layer of copper oxide. The electrode may be copper with sulfur nanoparticles. The electrode may be copper of high purity. A copper electrode accepts electrons as follows:

Cu⁺²+2e⁻→Cu

In a variant NaCl and/or O₂ is present in the electrolyte or at the electrode, in which case the electrode reaction follows:

Cu(s)+S(s)+2NaCl+2e⁻→Na₂S+CuCl₂

Cu(s)+O₂+2e⁻→CuO(s)

When electrons enter the electrode (Cu), they combine with Cl⁻ ions and oxygen which react to produce CuCl₂ (which is a powerful antimicrobial agent). Sodium ions can diffuse inside the electrolyte and react with sulfur in the electrolyte to produce sodium sulfide. The reverse reaction occurs during charging.

The other electrode typically is formed of a metal and/or a metallic alloy, such as lithium or zinc; in some embodiments, the electrode includes hydrogen. In preferred embodiments of the present disclosure, the other electrode is formed of magnesium and/or a magnesium alloy. The electrode may be magnesium covered by a thin layer of magnesium oxide. The electrode may be magnesium with sulfur nanoparticles. The electrode may be magnesium (optionally of high purity). A magnesium electrode donates electrons as follows:

Mg→Mg⁺²+2e⁻

Mg atoms on the surface of the electrode oxidize. As the Mg²⁺ ions move away from the electrode, the electrode becomes more negatively charged than the other electrode. When connected to a circuit, the excess electrons on the Mg electrode flow through the circuit forming an electric current.

The electrolyte 106 is arranged to provide a medium for the transfer of charged ions between the cathode 102 and the anode 104. This transfer of ions from the cathode 102 to the anode 104 results in the presence of free electrons at the anode 104, which are collected by the anode current collector 110. In practice, ions typically flow from the cathode 102 to the anode 104 when the battery 1 is discharging and from the anode 104 to the cathode 102 when the battery 1 is charging.

The electrolyte 106 is an electrical non-conductor to reduce ‘self-discharge’, which is the internal flow of electrons between the cathode 102 and the anode 104. In various embodiments, the electrolyte 106 includes a solvent, dissolved ions (e.g. from biocompatible salts), a polymer and/or a ceramic. In various embodiments, the electrolyte 106 includes a solid, a liquid, and/or a gel. In preferred embodiments of the present disclosure, the electrolyte 106 is a polysaccharide network formed from a gel with embedded carbon nanotubes. Preferred compositions of the electrode 106 are further described with reference to FIGS. 2a, 2b, 3 and 4.

As used herein, the term gel preferably refers to a non-fluid network that may be expanded throughout its whole volume by a fluid. As used herein, the term gel preferably refers to a xerogel, i.e. a network (or matrix) formed by the removal of swelling agents, such as liquids, from a gel. The term gel may refer to an aerogel, i.e. a gel formed of a microporous solid in which the dispersed phase is a gas. The term gel may refer to a polymer gel, i.e. a gel in which the network is a polymer network. The term gel may refer to a hydrogel, i.e. a gel in which the swelling agent is water.

The separator 114 is located between the cathode 102 and the anode 104 and is arranged to further reduce, or eliminate, self-discharge. The separator 114 is arranged to allow the flow of ions between the cathode 102 and the anode 104. The separator 114 is a porous and electrically non-conductive material; typically the separator 114 is formed of polyolefin. In some embodiments the separator 114 is formed of polyethylene, plastic, or rubber. The separator may be a polyethylene glycol film that serves as a solid electrolyte interface. In some embodiments the separator 114 is coated with ceramic, which ensures that the separator 114 does not melt at high temperatures. A wide variety of other materials and structures may be used for the separator.

The cathode current collector 108 is arranged to provide electrons from the external load 2 to the cathode 102 during the discharging of the battery 1. In typical embodiments, the cathode current collector 108 is a carbon based material, or a metal, such as nickel.

The anode current collector 110 is arranged to gather electrons provided by the anode 104 during the discharging of the battery 1 and provide these electrons to the external load 2. In typical embodiments, the anode current collector 108 is a metal, such as copper, platinum, and/or titanium.

The cathode current collector 108 and the anode current collector 110 are each capable of providing electrons to and from the external load 2, so that during charging of the battery 1, the cathode current collector 108 gathers electrons provided by the cathode 102 and provides these electrons to the external load 2 and the anode current collector 110 provides electrons from the external load 2 to the anode 104.

In some embodiments, there is not provided a cathode current collector 108 and/or an anode current collector 110. In these embodiments, electrons may be directly gathered from/directly provided to the cathode 102 and/or the anode 104.

In operation, during discharging, the anode 104 is oxidized, which provides positively charged ions that flow through the separator 114 to the cathode 102 via the electrolyte 106, and electrons that are collected by the anode current collector 110. These electrons flow from the anode current collector 110 to the cathode current collector 108 via the external load 2, which provides power to the external load 2. The cathode 102 receives the positively charged ions from the anode 104 and is reduced. The net energy generated from the combination of the oxidization of the anode 104 and the reduction of the cathode 102 is positive; the excess energy is transferred to the external load 2 via the electrons.

During charging, the external load 2 provides power to the battery 1 via electrons received at the anode current collector 110. Electrons flow from the cathode current collector 108 to the anode current collector 110 via the external load 2, during which the external load charges these electrons. The cathode 102 is oxidized, which provides electrons to the cathode current collector 108 and releases ions that are received by the anode 104, which is thereby reduced. The net energy generated by the combination of the reduction of the anode 104 and the oxidation of the cathode 102 is negative, that is energy is required for this process to occur. This excess energy is provided by the external load 2 via the electrons; the energy is stored and is released during subsequent discharging of the battery.

FIGS. 2a, 2b, 3 and 4 show various views of an exemplary implementation of the battery 1.

Referring to FIGS. 2a and 2b, the cathode 102, anode 104, and electrolyte 106 are disposed on a base substrate 202.

In this embodiment, one of the electrodes is magnesium, the other electrode is copper and the electrolyte 106 is a gel electrolyte with carbon nanotubes embedded in a polysaccharide matrix.

Within the electrolyte 106, the embedded carbon nanotubes (single- or multi-walled carbon nanotubes) lead to high conduction between the cathode 102 and the anode 104; the sulfur protects the magnesium against degradation; and the polysaccharide provides a biodegradable and environmentally friendly matrix in which these components may be embedded.

In an example chiral carbon nanotubes are provided in the electrolyte. Chirality of the carbon nanotubes can facilitate alignment and directionality of the carbon nanotubes, and improve performance of the electrolyte.

In an example sulfur nanoparticles are provided in the electrolyte. In a variant sulfur is provided in other than nanoparticle form. The provision of sulfur enables the use of magnesium in the electrode; this would typically be avoided in favour of, for example lithium, due to the comparatively high rate of degradation of magnesium. The sulfur within the electrolyte 106 has a stabilizing effect that reduces this degradation rate. Optionally the sulfur may be complemented with a nonionic surfactant to stabilize the sulfur in the gel electrolyte and prevent formation of sulfur clusters. It is observed that during operation the sulfur does not leak out of the electrolyte.

The sulfur inside the solid-state bio gel matrix can allow better performance of the cell battery because of its high reaction potential, and it works as a second oxidant agent producing higher mobility of electrons through the cell battery according to the following reactions:

S₈+4e⁻+2Mg⁺²→2MgS₄

MgS₄+2e⁻+Mg⁺²→2MgS₂

MgS₂+2e⁻+Mg⁺²→2MgS

In an example sulfur atoms are bound to the carbon nanotubes. By functionalising the carbon nanotubes with sulfur the properties of the carbon nanotubes can be tailored.

By virtue of the sulfur atoms being bound to the carbon nanotubes, the electrons generated at the anode can be attracted to the carbon atoms of the carbon nanotubes. The functionalization of carbon nanotubes with sulfur may be achieved using a cold plasma torch.

FIG. 3 shows a variant where the electrolyte 106 includes a base layer 204 that is formed of a polysaccharide gel. The electrolyte 106 further includes a second layer 206 of carbon nanotubes and sulfur nanoparticles embedded within a polysaccharide gel. In a variant the carbon nanotubes and sulfur are suspended throughout the gel instead of forming a layer at the interface of the gel.

The electrolyte 106 is non-explosive, not subject to evaporation, and recyclable. The electrolyte can be biodegraded and is ecologically benign. It can enable high energy density in batteries or capacitors. In an example an energy density of 1671 mA h g⁻¹ or 3459 mA h cm⁻³ is achieved. The electrolyte can be stored for extended periods without risk of being a source of harmful substances (e.g. by leaking or degrading components) and so can be transported cheaply and safely. The electrolyte can be easily produced in any geometrical shape.

The electrolyte 106 is formed using a natural polysaccharide, such as chitin, agarose, starch, pectin, or glycogen. Preferably, the polysaccharide is chitosan. In an example the degree of deacetylation of the chitosan is about 80%. In an example the average molecular weight of the chitosan is about 50 kDa, 200 kDa, 300 kDa, or 900 kDa, or 1250 kDA. In an example the viscosity of the chitosan is about 200 cPs at 10 mg/mL in 1% acetic acid at 20° C. Chitosan may be obtained by treating chitin, which can be obtained from the shells of shrimp or other crustaceans, with an alkaline substance. The forming of chitosan preferably uses water as a solvent. The water may be distilled water, deionized water, salt water, and/or mineral water. In the case of a solution of sodium chloride (NaCl) in water an ion-dipole force is established, that is eliminated in further process of the construction of the cell.

Chitosan is soluble in water, so that forming the electrolyte 106 based upon chitosan ensures that the battery 1 is readily biodegradable.

Alternatively, the polysaccharide is agarose. Agarose is a natural polymer derived from sea algae and is formed of disaccharides made up of D-galactose and 3,6-anhydro-L-galactopyranose. Agarose has a high mechanical strength and can form a rigid porous network. Agarose is soluble in water, so that forming the electrolyte 106 based upon agarose ensures that the battery 1 is readily biodegradable.

An agarose matrix typically has a melting temperature between 80-98° C., and once molten remains melted until a lower gelling temperature, typically between 30-55° C. The ability of agarose to melt at elevated temperatures and return to solid at lower temperatures can benefit the performance of the electrolyte. During charging of the battery the temperature of the battery can become elevated, causing the agarose to melt and the electrolyte to become a liquid instead of a solid. In the liquid state the electrolyte can provide more efficient charge transfer, and faster, more efficient charging can be achieved. Once the temperature decreases below a threshold, for example after charging is stopped, the agarose gels again and the electrolyte returns to being a solid again.

An matrix can be supplemented with polyethylene glycol. The matrix may be a double-network matrix with both e.g. an agarose network and a polyethylene glycol network. Alternatively the polyethylene glycol may be dispersed within the polysaccharide matrix without forming a polyethylene glycol network. The polyethylene glycol (as a network or dispersed) can mechanically strengthen the matrix and can provide a matrix with a higher melting point than e.g. an agarose matrix alone, which can enable drying of the electrolyte at a higher temperature and more efficient elimination of water from the matrix. The polyethylene glycol can also interact with the carbon nanotubes and endow hydrophilic characteristics to the carbon nanotubes. In an example the polyethylene glycol has an average molecular weight of approximately 1 kDa to 10 kDa, though other polyethylene glycols may be used.

The electrolyte 106 is typically formed by suspending carbon nanotubes in a polysaccharide solution, orienting the nanotubes, and then dehydrating the solution to obtain a xerogel. The carbon nanotubes may be arranged at an interface layer of the electrolyte, or suspended throughout the electrolyte. The arranging and dispersing of the carbon nanotubes may be assisted by ultrasonic treatment. The orienting of carbon nanotubes may involve electrophoresis, where an electric field is applied across the solution. Dehydrating the solution may involve mechanical dehydration, where, for example, heated air is passed over the solvent to remove substantially all solvent. This leads to the formation of a xerogel. The formation of the electrolyte may include exposure of the electrolyte to irradiation. For example ultraviolet (UV) irradiation may assist in formation of the electrolyte. In an example UV irradiation at a wave length of 200 nm to 300 nm is used, e.g. 240 nm. An example of an irradiation dose may be 5 kJ to 50 kJ, e.g. 30 minutes at 12 watt.

In some examples sulfur nanoparticles are embedded in the gel. In some examples the sulfur nanoparticles are additionally or alternatively bound to the carbon nanotubes. The presence of sulfur can improve performance of the battery 1 at least by working as a second oxidant. By virtue of the stabilizing effect of the sulfur nanoparticles (in particular with the magnesium electrode) rapid recharge cycles can be enabled. The sulfur can control the transit of electrons between the electrode (magnesium) and can allow the battery to become a secondary cell and a super capacitor allowing the magnesium to recover its electrons once it is recharged. Other ions as described herein can alternatively replace the sulfur.

The use of polysaccharides for the electrolyte 106 enables nanomaterials to be embedded inside a matrix that is biodegradable and environmentally friendly. Further, the use of polysaccharide for the electrolyte can reduce the operating temperature of the battery 1. The polysaccharide electrolyte 106 can enable favourable temperature stability, even at high temperatures (for example up to 700° C.). Moreover, the use of polysaccharide for the electrolyte can help reduce the temperature of the battery making it very stable even in fire conditions.

The polysaccharide electrolyte 106 is provided in the form of a gel (xerogel) and is useable as part of a solid-state battery with no liquid electrolyte. This allows simple manipulation of the shape of the battery, and avoids the need for heavy, incompressible liquid electrolytes. In some examples the entire unit or cell can deliver power in geometries as little as one millimetre square and even smaller. In an example a power density of 1675 mA h g⁻¹ with voltages of 1.5 volts can be achieved, comparable to an AA battery.

The electrolyte 106 can be supplemented with further dissolved ions (in addition to the sodium Na⁺, chloride Cl⁻, magnesium Mg²⁺ ions described above) such as phosphate ions PO₄³⁻ and other phosphates, potassium cations K⁺, sulfate ions SO₄²⁻, calcium cations Ca²⁺, bromide Br⁻, boron B species such as boric acid and borates, strontium cations Sr²⁺, or fluoride F⁻. Potassium and phosphates and other ions can participate in the electrochemical reaction and improve the charge transport in the electrolyte. Sodium chloride ions can enable favourable charge mobility in the electrolyte and at an electrode. Inclusion of different ions in the electrolyte can assist in maintaining a pH in the electrolyte that is relatively constant in different charge states, for example remaining relatively constant around pH 7. The electrolyte can be supplemented by sea water, which can provide both high saline density (e.g. between 30 and 40% salinity, e.g. 0.546 mol/kg of Cl⁻, 0.469 mol/kg of Na⁺) and a mixture of further dissolved ions (e.g. 0.0528 mol/kg of Mg²⁺, 0.0282 mol/kg of SO₄²⁻, 0.0103 mol/kg of Ca²⁺, 0.0102 mol/kg of K⁺, 0.000844 mol/kg of Br⁻, 0.000416 mol/kg of boron B species, 0.000091 mol/kg of Sr²⁺, 0.000068 mol/kg of F⁻). The electrolyte can be a synthetic solution of dissolved ions with similar concentrations as sea water, or a subset of dissolved ions found in sea water.

In some variants of the electrolyte the sulfur nanoparticles embedded in the matrix are omitted. In some variants of the electrolyte the carbon nanotubes are not functionalised with sulfur. In some variants of the electrolyte the sulfur nanoparticles embedded in the matrix are omitted and the carbon nanotubes are not functionalised with sulfur.

In a variant the electrolyte 106 itself, rather than a distinct anode, is arranged to be oxidized/reduced during the charging/discharging of the battery 1; this oxidization/reduction provides electrons that are collected from the electrolyte 106 by the anode current collector 110. The electrode in this variant is not a metal and/or a metallic alloy part, but instead the electrolyte 106 performs as both electrolyte and electrode.

FIG. 4 shows a cross sectional view of a battery 300 where the electrolyte 306 performs as electrode. An electrolyte 306 is disposed between an anode current collector 312 and a cathode 102 with a cathode current collector 108. The anode current collector, cathode and cathode current collector are as described above. A separator 114 may be included as described above. Preferably the cathode is magnesium as described above. In an example a magnesium electrode with a particular shape is inserted into the electrolyte 306 to produce a battery with a specific desired three-dimensional shape.

In an exemplary implementation of this variant, the electrolyte 306 is as described above.

In a variant the polysaccharide electrolyte 106 can be used in a capacitor such as a supercapacitor or a secondary cell battery.

Various other modifications will be apparent to those skilled in the art.

It will be understood that the present disclosure has been described above purely by way of example, and modifications of detail can be made within the scope of the invention.

Reference numerals appearing in the claims are by way of illustration only and shall have no limiting effect on the scope of the claims.

As used herein, the term ‘to comprise’ is to be interpreted broadly and may be understood to mean ‘to include’.

1. An electrolyte comprising:
a polysaccharide matrix; and
carbon nanotubes embedded within the polysaccharide matrix.

2. The electrolyte of claim 1, further comprising sulfur embedded within the polysaccharide matrix.

3. The electrolyte of claim 2, wherein the sulfur is in the form of sulfur nanoparticles.

4. The electrolyte of claim 2 or 3, wherein the sulfur is bound to the carbon nanotubes.

5. The electrolyte of any preceding claim, wherein the carbon nanotubes are chiral carbon nanotubes.

6. The electrolyte of any preceding claim, wherein the polysaccharide is derived from a natural polysaccharide, preferably at least one of: chitin, agarose, starch, and/or glycogen.

7. The electrolyte of any preceding claim, wherein the polysaccharide is agarose.

8. The electrolyte of any preceding claim, wherein the polysaccharide has a melting temperature between 70 and 110° C.

9. The electrolyte of any preceding claim, wherein the polysaccharide is chitosan, preferably obtained from the shells of crustaceans.

10. The electrolyte of claim 9, wherein the chitosan has a degree of deacetylation of 60-95%, preferably 70-90%, and more preferably approximately 80%.

11. The electrolyte of claim 9 or 10, wherein the chitosan has an average molecular weight of 50 to 1500 kDa, preferably 50 to 900 kDa, preferably 50 to 300 kDa, and more preferably approximately 200 kDa.

12. The electrolyte of any preceding claim, further comprising a nonionic surfactant.

13. The electrolyte of any preceding claim, further comprising one or more of: sodium cations; chloride; phosphate; and potassium cations.

14. The electrolyte of any preceding claim, further comprising polyethylene glycol.

15. The electrolyte of any preceding claim, wherein the carbon nanotubes are functionalized with sulfur, preferably using a torch of cold plasma.

16. The electrolyte of any preceding claim, wherein the carbon nanotubes are oriented within the matrix, preferably using an electrophoresis process.

17. The electrolyte of any preceding claim, wherein the carbon nanotubes and/or the sulfur is arranged at an interface of the polysaccharide matrix and/or dispersed throughout the polysaccharide matrix, optionally using an ultrasound treatment.

18. The electrolyte of any preceding claim, wherein the electrolyte is formed by exposure of the electrolyte to irradiation, preferably ultraviolet irradiation, more preferably irradiation at 200 nm to 300 nm.

19. Apparatus comprising the electrolyte of any preceding claim, further comprising:
a first electrode; and
optionally a second electrode;
wherein the electrolyte is disposed adjacent the first electrode and optionally between the first electrode and the second electrode.

20. Apparatus of claim 19, wherein the first electrode comprises magnesium and optionally the second electrode comprises copper.

21. Apparatus of claim 19 or 20, wherein one of the first electrode and/or the second electrode comprises sulfur, preferably sulfur nanoparticles.

22. A battery or capacitor comprising the electrolyte of any of claims 1 to 18 or the apparatus of any of claims 19 to 21.

23. A battery or capacitor according to claim 22, wherein the battery or capacitor is at least one of: a solid-state battery or capacitor, a biodegradable battery or capacitor, and a flexible battery or capacitor.

24. A method of manufacturing an electrolyte, the method comprising:
providing a polysaccharide solution;
suspending carbon nanotubes within the polysaccharide solution; and
dehydrating the polysaccharide solution to obtain a gel.

25. The method of claim 24, wherein the polysaccharide solution is a chitin or chitosan or agarose solution.

26. The method of claim 24 or 25, wherein the polysaccharide solution comprises at least: polysaccharide, water, and optionally one or more of: sodium cations; chloride; phosphate; potassium cations; and polyethylene glycol.

27. The method of any of claims 24 to 26, further comprising arranging the carbon nanotubes at an interface of the polysaccharide matrix and/or dispersed throughout the polysaccharide matrix, optionally using an ultrasound treatment.

28. The method of any of claims 24 to 27, further comprising orienting the carbon nanotubes within the polysaccharide solution, preferably wherein orienting the carbon nanotubes comprises using an electrophoresis process.

29. The method of any of claims 24 to 28, wherein dehydrating the polysaccharide solution comprises mechanically dehydrating the polysaccharide solution.

30. The method of any of claims 24 to 29, further comprising suspending sulfur within the polysaccharide solution.

31. The method of claim 30, wherein the sulfur is sulfur nanoparticles.

32. The method of claim 30 or 31, further comprising binding the sulfur to the carbon nanotubes, preferably using a torch of cold plasma.

33. The method of any of claims 24 to 32, wherein providing a polysaccharide solution comprises treating chitin to obtain chitosan, preferably wherein the chitin is obtained from the shells of crustaceans.

34. The method of any of claims 24 to 33, wherein the carbon nanotubes are chiral carbon nanotubes.

35. The method of any of claims 24 to 34, further comprising exposure of the electrolyte to irradiation, preferably ultraviolet irradiation, more preferably irradiation at 200 nm to 300 nm.

36. A method of manufacturing apparatus comprising manufacturing the electrolyte of any of claims 24 to 35, further comprising:
providing a first electrode;
optionally providing a second electrode; and
disposing the electrolyte adjacent the first electrode and optionally between the first electrode and the second electrode.

37. The method of claim 36, wherein the first electrode comprises magnesium and optionally the second electrode comprises copper.

38. A method of manufacturing a battery or capacitor comprising manufacturing the electrolyte of any of claims 24 to 35 or manufacturing apparatus of any of claim 36 or 37.

39. A method according to claim 38, wherein the battery or capacitor is at least one of: a solid-state battery or capacitor, a biodegradable battery or capacitor, and a flexible battery or capacitor.
